(19) United States
(12) Patent Application Publication
(10) Pub. No.: US 2018/0307933 A1
(43) Pub. Date: Oct. 25, 2018

(54) IMAGE PROCESSING APPARATUS, IMAGE PROCESSING METHOD, AND COMPUTER READABLE RECORDING MEDIUM

(71) Applicant: OLYMPUS CORPORATION, Tokyo (JP)

(72) Inventor: Hidekazu IWAKI, Tokyo (JP)

(73) Assignee: OLYMPUS CORPORATION, Tokyo (JP)

(21) Appl. No.: 16/011,707

(22) Filed: Jun. 19, 2018

Related U.S. Application Data
(63) Continuation of application No. PCT/JP2015/086569, filed on Dec. 28, 2015.

(51) Int. Cl. G06K 9/32; G06T 7/00

(52) U.S. Cl. CPC G06K 9/3241; G06T 2207/10024; G06T 2207/10068; G06T 7/0012

(57) ABSTRACT

An image processing apparatus includes: an object image acquiring unit configured to acquire an object image as first image data; a region-of-interest detecting unit configured to detect, based on feature data of the object image, a region of interest that is a target region of interest; an image data generating unit configured to generate second image data that is image data including an indication image indicating information related to the region of interest in the object image and that has an amount of information smaller than an amount of information of the first image data; and a display controller configured to perform control such that a second image corresponding to the second image data is displayed. A first image corresponding to the first image data is displayed in a first display region, and the second image corresponding to the second image data is displayed in a second display region.

### CROSS-REFERENCE TO RELATED APPLICATION

This application is a continuation of International Application No. PCT/JP2015/086569, filed on Dec. 28, 2015, the entire contents of which are incorporated herein by reference.

### BACKGROUND

The present disclosure relates to an image processing apparatus, an image processing method, and a computer readable recording medium.

In the medical field and the industrial field, endoscope apparatuses are widely used for various examinations. From among these, endoscope apparatuses for medical use become popular due to less stressful with respect to a subject because an in-vivo image (object image) inside the subject may be acquired without making an incision in the subject by inserting, into inside the subject, such as a patient, an elongated flexible insertion unit in which an image sensor having a plurality of pixels is provided at a distal end.

When observing an object image by using such an endoscope apparatus, information that indicates a region of interest, such as a lesion detection result, is displayed on an observation screen as the result of image analysis. The information that indicates the region of interest is displayed on a predetermined position such that the information is superimposed with respect to the region of interest in the object image by using a predetermined method (for example, see Japanese Laid-open Patent Publication No. 2011-255006). However, if, as the information that indicates the region of interest, for example, a mark is displayed on the object image in a superimposed manner, there is a problem in that it is not able to observe the region that is superimposed on the mark in the object image.

To solve this problem, there is a disclosed method of dividing a display region into two; displaying, in a first display region, an object image; and displaying, in a second display region that is smaller than the first display region, an object image to which a mark indicating a region of interest is added (for example, see Japanese Laid-open Patent Publication No. 10-262923 and Japanese Patent No. 4989036).

### SUMMARY

An image processing apparatus according to one aspect of the present disclosure includes: an object image acquiring unit configured to acquire an object image as first image data; a region-of-interest detecting unit configured to detect, based on feature data of the object image, a region of interest that is a target region of interest; an image data generating unit configured to generate second image data that is image data including an indication image indicating information related to the region of interest in the object image and that has an amount of information smaller than an amount of information of the first image data; and a display controller configured to perform control such that a second image corresponding to the second image data is displayed, wherein a first image corresponding to the first image data is displayed in a first display region, and the second image corresponding to the second image data is displayed in a second display region.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram illustrating, in outline, the configuration of an endoscope apparatus according to an embodiment;

FIG. 2 is a schematic diagram illustrating, in outline, the configuration of the endoscope apparatus according to the embodiment;

FIG. 3 is a flowchart illustrating a process performed by the endoscope apparatus according to the embodiment;

FIG. 4 is a diagram illustrating a display screen displayed by a display of the endoscope apparatus according to the embodiment;

FIG. 5 is a diagram illustrating a display screen displayed by a display of the endoscope apparatus according to a first modification of the embodiment;

FIG. 6 is a diagram illustrating a display screen displayed by a display of the endoscope apparatus according to a second modification of the embodiment;

FIG. 7 is a diagram illustrating a display screen displayed by a display of the endoscope apparatus according to a third modification of the embodiment;

FIG. 8 is a diagram illustrating a display screen displayed by a display of the endoscope apparatus according to a fourth modification of the embodiment; and

FIG. 9 is a diagram illustrating, in outline, the configuration of an endoscope apparatus according to a fifth modification of the embodiment.

### DETAILED DESCRIPTION

In the following, embodiments will be described below with reference to the accompanying drawings. In the embodiment, a description will be given, as an example of a device including an image processing apparatus, an endoscope apparatus for medical use that captures an image inside a subject, such as a patient. Furthermore, the present disclosure is not limited to the embodiment. Furthermore, the same reference signs are used to designate the same elements throughout the drawings.

### Embodiment

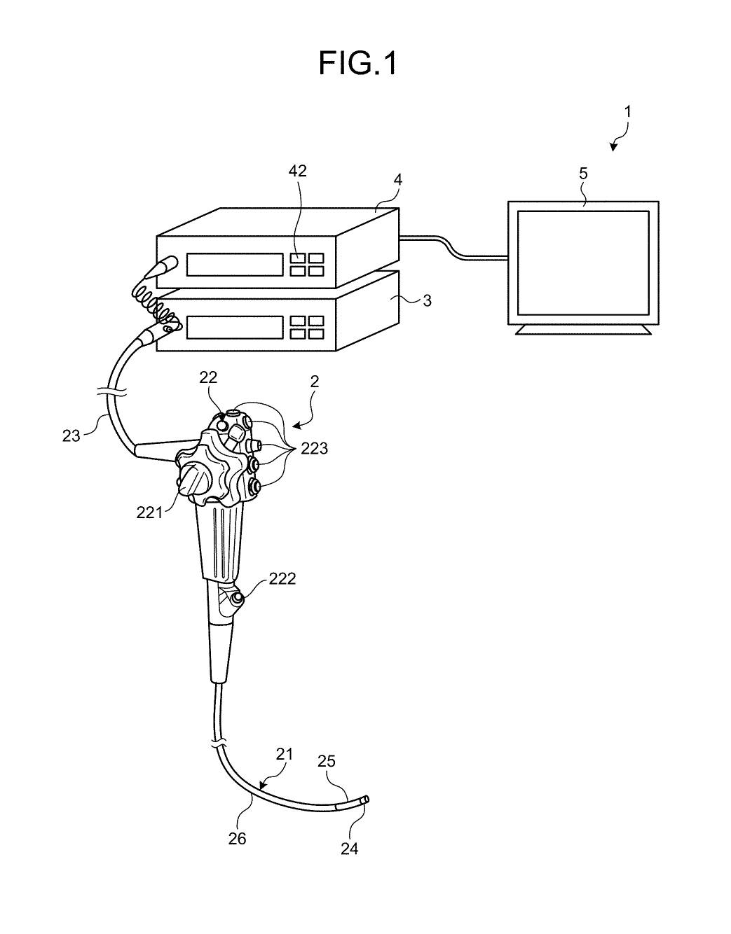

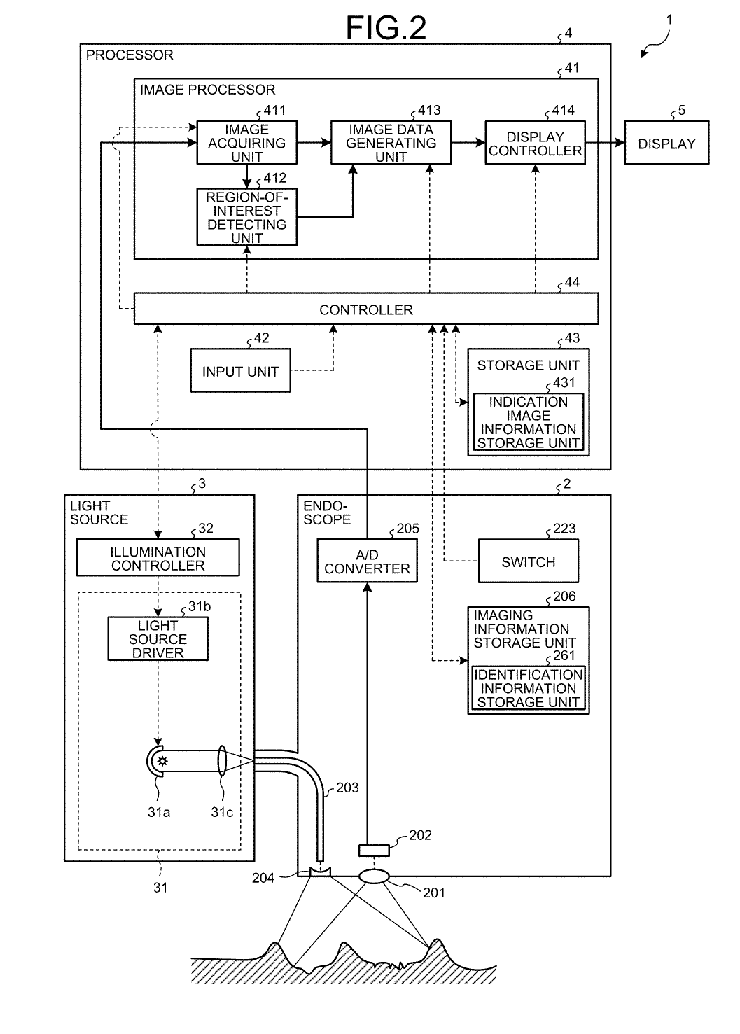

FIG. 1 is a diagram illustrating, in outline, the configuration of an endoscope apparatus 1 according to an embodiment. FIG. 2 is a schematic diagram illustrating, in outline, the configuration of the endoscope apparatus 1 according to the embodiment. The endoscope apparatus 1 illustrated in FIGS. 1 and 2 includes an endoscope 2 that captures an in-vivo image of an observed region by inserting an insertion unit 21 into a subject and that generates an electrical signal; a light source 3 that produces illumination light emitted from the distal end of the endoscope 2; a processor 4 that performs predetermined image processing on an electrical signal acquired by the endoscope 2 and that performs overall control of the overall operation of the endoscope apparatus 1; and a display 5 that displays the in-vivo image that has been subjected to image processing by the processor 4. The endoscope apparatus 1 inserts the insertion unit 21 into the subject, such as a patient, and acquires the in-vivo image inside the subject. A surgeon, such as a doctor, examines a bleeding site that is a detection target site or examines presence or absence of a tumor site by observing the acquired in-vivo image.

The endoscope 2 includes the insertion unit 21 that is flexible and that has an elongated shape; an operating unit 22 that is connected to at the proximal end side of the insertion unit 21 and that receives an input of various operation signals; and a universal cord 23 that extends from the operating unit 22 in the direction different from the direction in which the insertion unit 21 extends and that has various built-in cables connected to the light source 3 and the processor 4.

The insertion unit 21 includes a distal end portion 24 in which pixels (photodiodes) that receive light are arrayed in a grid (matrix) shape and that has a built-in image sensor 202 that generates an image signal by performing photoelectric conversion on the light received by the pixels; a curved portion 25 that is formed so as to be capable of being freely curved by a plurality of curved pieces; and a flexible tube portion 26 having a flexible elongated shape connected to the proximal end of the curved portion 25.

The operating unit 22 includes a curved knob 221 that curves the curved portion 25 in the vertical direction and in the horizontal direction; a treatment instrument insertion unit 222 from which a treatment instrument, such as biological forceps, an electric scalpel, and examination probe, is inserted into a subject; and a plurality of switches 223 that inputs an instruction signal for allowing the light source 3 to perform a switching operation of illumination light, an operation instruction signal for operating the treatment instrument or operating an external apparatus that is connected to the processor 4, a water-supply instruction signal for supplying water, a suction instruction signal for suction, and the like. The treatment instrument inserted from the treatment instrument insertion unit 222 is output outside from an opening (not illustrated) via a treatment instrument channel (not illustrated) provided at the distal end of the distal end portion 24.

The universal cord 23 includes a light guide 203, an assembled cable formed by assembling one or a plurality of signal lines. The assembled cable is a signal line that sends and receives a signal between the endoscope 2 and the light source 3 or the processor 4 and that includes a signal line for sending and receiving set data, a signal line for sending and receiving an image signal, a signal line for sending and receiving a driving timing signal for driving the image sensor 202, and the like.

Furthermore, the endoscope 2 includes an imaging optical system 201, the image sensor 202, the light guide 203, an illumination lens 204, an A/D converter 205, and an imaging information storage unit 206.

The imaging optical system 201 is provided at the distal end portion 24 and collects the light from at least an observed region. The imaging optical system 201 is constituted by using one or more lenses. Furthermore, in the imaging optical system 201, an optical zoom mechanism that changes the angle of view or a focus mechanism that changes a focal point may also be provided.

The image sensor 202 is provided perpendicular to the optical axis of the imaging optical system 201 and generates an electrical signal (imaging signal) by performing photoelectric conversion on the image of the light imaged by the imaging optical system 201. The image sensor 202 is implemented by using a charge coupled device (CCD) image sensor, a complementary metal oxide semiconductor (CMOS) image sensor, and the like.

The light guide 203 is constituted by using glass fibers or the like and forms a light guide path of the light emitted from the light source 3.

The illumination lens 204 is provided at the distal end of the light guide 203, diffuses the light guided by the light guide 203, and emits the light outside the distal end portion 24.

The A/D converter 205 performs A/D conversion by converting the electrical signal generated by the image sensor 202 and outputs the converted electrical signal to the processor 4. The A/D converter 205 converts the electrical signal generated by the image sensor 202 to, for example, 12-bit digital data (image signal).

The imaging information storage unit 206 stores therein data including various programs for operating the endoscope 2, various parameters needed for the operation of the endoscope 2, identification information on the endoscope 2, and the like. Furthermore, the imaging information storage unit 206 includes an identification information storage unit 261 that stores therein the identification information. In the identification information, information related to the unique information (ID) the model year, specification information, a transmission method about the endoscope 2 is included. The imaging information storage unit 206 is implemented by a flash memory, or the like.

In the following, the configuration of the light source 3 will be described. The light source 3 includes an illumination unit 31 and an illumination controller 32.

The illumination unit 31 changes, under the control of the illumination controller 32, a plurality of pieces illumination light each having a different wavelength band and emits the illumination light. The illumination unit 31 includes a light source element 31a, a light source driver 31b, and a condenser lens 31c.

The light source element 31a emits, under the control of the illumination controller 32, white illumination light including the light with a red, a green, and a blue wavelength bands H_{R}, H_{G}, and H_{B}, respectively. The white illumination light emitted from the light source element 31a is emitted outside from the distal end portion 24 after passing through the condenser lens 31c and the light guide 203. The light source element 31a is implemented by using a light source, such as a white LED and a xenon lamp, that emits white light.

The light source driver 31b supplies, under the control of the illumination controller 32, the current to the light source element 31a, thereby emitting the white illumination light to the light source element 31a.

The condenser lens 31c collects the white illumination light emitted from the light source element 31a and outputs the light outside (the light guide 203) the light source 3.

The illumination controller 32 controls the emission of the illumination light by controlling the light source driver 31b and allowing the light source element 31a to perform an on/off operation.

In the following, the configuration of the processor 4 will be described. The processor 4 includes an image processor 41, an input unit 42, a storage unit 43, and a controller 44.

The image processor 41 performs predetermined image processing based on the imaging signal received from the endoscope 2 (the A/D converter 205) and generates a display image signal that is used by the display 5 for a display. The image processor 41 includes an image acquiring unit 411, a region-of-interest detecting unit 412, an image data generating unit 413, and a display controller 414.

The image acquiring unit 411 receives an imaging signal from the endoscope 2 (the A/D converter 205). The image acquiring unit 411 performs, on the acquired imaging signal, signal processing, such as noise removal, A/D conversion, a synchronization process (for example, this is performed when an imaging signal for each color component is obtained by using a color filter or the like), or the like. The image acquiring unit 411 generates an image signal including an object image to which RGB color components are added by the signal processing described above. The image acquiring unit 411 inputs the generated image signal to both the region-of-interest detecting unit 412 and the image data generating unit 413. The image acquiring unit 411 may also perform, in addition to the synchronization process described above, an OB clamping process, a gain adjustment process, or the like.

The region-of-interest detecting unit 412 detects, based on the input image generated by the image acquiring unit 411, whether there is a possibility that a lesion is present in an input image and whether the region of interest that is a target region of interest is present. The region-of-interest detecting unit 412 detects the region of interest by detecting a lesion based on feature data of the object image. An example of the feature data includes a luminance value and a signal value of each of the color components (RGB components). Various technologies for detecting a lesion have been proposed and the technology disclosed by, for example, “Towards Automatic Polyp Detection with a Polyp Appearance Model” Jorge Bernal, F. Javier Sanchez, & Fernando Vilarino, Pattern Recognition, 45(9), 3166-3182, may be used for implementation. If the region-of-interest detecting unit 412 detects a lesion, the region-of-interest detecting unit 412 generates detection information related to the coordinates of the center of gravity of the lesion in the input image or the magnitude of the lesion and inputs the detection information to the image data generating unit 413.

The image data generating unit 413 performs a color conversion process on the image signal (object image) generated by the image acquiring unit 411 into, for example, sRGB (XYZ color system) color space that is the color gamut of the display 5; performs grayscale conversion based on the predetermined grayscale conversion characteristics, an enlargement process, structure enhancement processing on the structure of a capillary blood vessel on the surface layer of the mucosa or the structure of a fine pattern of the mucosa, and the like; and generates first image data that includes the object image. Furthermore, if detection information on the lesion is input from the region-of-interest detecting unit 412, the image data generating unit 413 generates, in addition to the first image data that has been subjected to the processes described above, second image data that includes an indication image indicating the information related to the region of interest detected by the region-of-interest detecting unit 412 and that has the amount of information smaller than that of the first image data. Furthermore, if the detection information on the lesion is not input from the region-of-interest detecting unit 412, the image data generating unit 413 creates only the first image data without creating the second image data.

The display controller 414 performs, under the control of the controller 44, control of an input and display of the image data (the first image data or, alternatively, the first and the second image data) generated by the image data generating unit 413 onto the display 5.

The input unit 42 is an interface for performing, for example, an input received from a surgeon with respect to the processor 4 and is constituted by including a power supply switch for switching on/off of the power supply, a mode switch button for switching an image capturing mode or other various modes, an illumination light switch button for switching on/off of the illumination light of the light source 3, and the like.

The storage unit 43 stores various programs, such as an image processing program, used for operating the endoscope apparatus 1 and data including, various parameters needed for the operation of the endoscope apparatus 1, and the like. The storage unit 43 is implemented by using a semiconductor memory, such as a flash memory or a dynamic random access memory (DRAM). The storage unit 43 includes an indication image information storage unit 431 that stores therein information that indicates the region of interest in the displayed image, for example, an indication image and the like.

The controller 44 is constituted by a CPU or the like, performs drive control of each component including the endoscope 2 and the light source 3, performs input/output control of information with respect to each component, and the like. The controller 44 sends, to the endoscope 2 via a predetermined signal line, the set data (for example, pixels to be read) used for imaging control stored in the storage unit 43, a timing signal needed for the image capturing timing, and the like.

In the following, the display 5 will be described. The display 5 receives a display image signal generated by the processor 4 via a video image cable and displays an in-vivo image corresponding to the display image signal. The display 5 is formed by using a liquid crystals or an organic electroluminescence (EL).

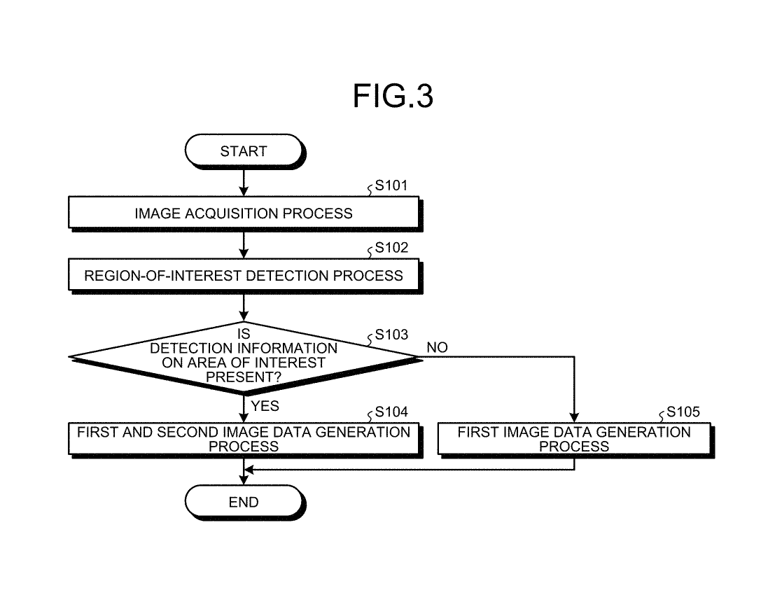

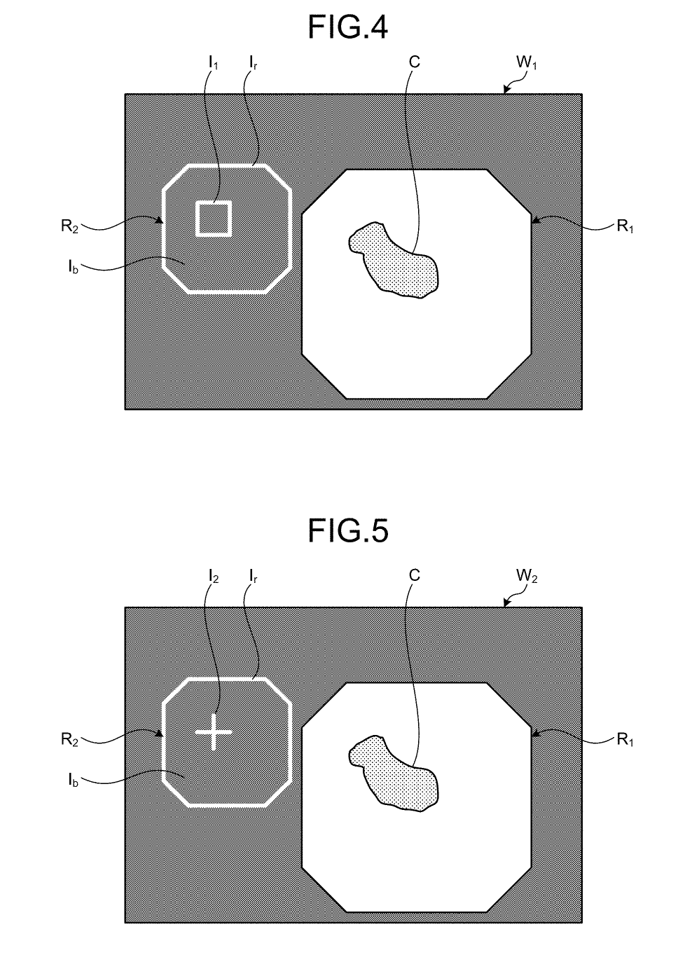

Subsequently, a process performed by each of the units in the processor 4 in the endoscope apparatus 1 will be described with reference to the drawings. FIG. 3 is a flowchart illustrating a process performed by the endoscope apparatus 1 according to the embodiment. FIG. 4 is a diagram illustrating a display screen W₁ displayed by the display 5 of the endoscope apparatus 1 according to the embodiment. In the following, a description will be given with the assumption that each of the units operates under the control of the controller 44.

First, the image acquiring unit 411 acquires, from the endoscope 2, an imaging signal that has been subjected to digital conversion (Step S101). The image acquiring unit 411 performs, as described above, signal processing, such as noise removal, A/D conversion, and the synchronization process, on the acquired imaging signal and generates an image signal that includes the object image to which the RGB color components are added. The image acquiring unit 411 inputs the generated image signal to the region-of-interest detecting unit 412 and the image data generating unit 413.

Subsequently, the region-of-interest detecting unit 412 detects, based on the input image generated by the image acquiring unit 411, whether a region of interest (for example, a region of interest C illustrated in FIG. 4) in which a lesion may possibly be present is present in the input image (Step S102). If the region-of-interest detecting unit 412 has detected the lesion, the region-of-interest detecting unit 412 generates detection information that is related to the coordinates of the center of gravity of the region of interest C, in which a lesion may possibly be present, in the object image and related to the size of the region of interest C and then inputs the detection information to the image data generating unit 413.

At Steps S103 to S105 subsequent to Step S102, the image data generating unit 413 generates image data. First, the image data generating unit 413 determines whether an input of the detection information is received from the region-of-interest detecting unit 412 (Step S103). Here, if an input of the detection information is received from the region-of-interest detecting unit 412 (Yes at Step S103), the image data generating unit 413 proceeds to Step S104. In contrast, if an input of the detection information is not received from the region-of-interest detecting unit 412 (No at Step S103), the image data generating unit 413 proceeds to Step S105.

At Step S104, the image data generating unit 413 generates the first image data based on the image signal that has been generated by the image acquiring unit 411 and generates the second image data that includes the indication image that is based on the detection information. Specifically, as illustrated in FIG. 4, the image data generating unit 413 generates the first image data that includes the object image and that is displayed in a first display region R₁ in the display 5 and the second image data that includes an indication image I₁ indicating the information related to the region of interest in the object image and that has an amount of information smaller than that of the first image data.

Here, the second image data has a similar relationship with the indication image I₁ that indicates the information related to the region of interest C, has a similar relationship with the contour of the first display region R₁, and includes a contour image Iᵣ that forms the contour of a second display region R₂ and a background image I_{b} that forms the background of the second display region R₂. In the embodiment, the background image I_{b} is generated by the same color of the background that is other than the first display region R₁ on the display screen W₁. Furthermore, the indication image I₁ is a rectangular ring shaped diagram and is generated by using the inverted color (complementary color) of the average color of the object image displayed on the first display region R₁. The indication image I₁ is arranged such that the center position of the rectangle associated with, for example, the contour image Iᵣ corresponds to the position of the center of gravity of the region of interest C associated with the contour of the first display region R₁. The contour image Iᵣ has a ring shape similar to the shape around the contour of the first display region R₁ and is generated by the inverted color (complementary color) of the color (color of the display region other than the color of the first display region R₁) of the background image I_{b}. The second image data is formed by monochrome color information on each of the images (the indication image I₁, the contour image Iᵣ, and the background image I_{b}), has a smaller number of colors compared with the object image formed by a plurality of pieces of color information on an image of, for example, inside a lumen of a subject, and the amount of information (amount of data) is small.

At Step S105, the image data generating unit 413 generates the first image data based on the image signal generated by the image acquiring unit 411.

By performing the processes described above, the first image data to be displayed in the first display region R₁ in the display 5 and the second image data to be displayed in the second display region R₂ are generated in accordance with presence or absence of the detection information on the region of interest. The display controller 414 performs control, under the control of the controller 44, such that the image data is input and displayed onto the display 5. A surgeon observes the object images (the first image data) that are sequentially displayed on the display 5 and checks the indication image I₁ because the indication image I₁ is displayed when the region of interest is detected, whereby the surgeon may easily grasp which position is the region of interest that is present in the object image. Consequently, it is possible to reduce an oversight of the lesion.

According to the embodiment described above, the region-of-interest detecting unit 412 detects, based on the feature data of the object image, the region of interest that is the target region of interest; the image data generating unit 413 generates, in accordance with the detection information on the region of interest, the first image data that includes the object image and the second image data that includes the indication image indicating the information related to the region of interest in the object image and that has an amount of information smaller than that of the first image data; and the display controller 414 performs control of display such that the first image corresponding to the first image data is displayed in the first display region in the display and the second image corresponding to the second image data is displayed in the second display region. Consequently, it is possible to guide the position of the region of interest in the object image without overlapping the indication image that indicates the region of interest with the object image, ensure the visibility of the object image, and improve the visibility of the information that indicates the region of interest in the object image.

Furthermore, according to the embodiment, because the color of the background in the second display region R₂ is set to monochrome, for example, black and the color of the indication image I₁ is set to white having the contrast higher than the background color in the second display region R₂, it is possible to improve the visibility of the indication image I₁ in the second display region R₂.

Furthermore, in the embodiment described above, by setting the color of the indication image I₁ and the background color in the second display region R₂ is set to monochrome, an amount of information is made small by reducing the number of colors; whoever, a combination of colors is not limited to this. For example, the background color in the second display region R₂ may also be represented in white and the color of the indication image I₁ may also be represented in black by inverting the brightness of the background color in the second display region R₂ or the background color in the second display region R₂ may also be represented in black or white and the color of the indication image I₁ may also be represented in the color other than black or white. Furthermore, if the background color in the second display region R₂ is the color other than black or white, the color of the indication image I₁ may also be represented in black, white, or may also be represented in the complementary color of the background color in the second display region R₂. Furthermore, it may also possible to set the background color in the second display region R₂ to the average color of the object image displayed in the first display region R₁ and set the color of the indication image I₁ to the complementary color of the average color of the object image displayed on the first display region R₁. It may also possible to set the background color in the second display region R₂ to monochrome, such as black, and set the color of the indication image I₁ to the complementary color of the average color of the object image displayed in the first display region R₁. Furthermore, it may also possible to set the background in the second display region R₂ to be associated with the object image displayed in the first display region R₁, set the background in the second display region R₂ to an image, in which at least one of the resolution, the saturation, the brightness, and the contrast is reduced with respect to the object image displayed in the first display region R₁, and reduce an amount of information of the second image data. For example, the background in the second display region R₂ is formed by reducing at least one of the resolution, the saturation, the brightness, and the contrast based on the object image displayed in the first display region R₁. Furthermore, the amount of information may be reduced by lowering a refresh rate of the display image in the second display region R₂ with respect to the refresh rate of the object image displayed in the first display region R₁. By lowering the refresh rate of the display image in the second display region R₂ with respect to the refresh rate of the object image displayed in the first display region R₁, because an amount of change in the position of the indication image I₁ in the second display region R₂ obtained before and after an update is increased, it is possible to more certainly grasp a change in position of the indication image I₁.

### First Modification of Embodiment

In the embodiment described above, a description has been given of a case in which the indication image I₁ has a rectangular ring shape; however, the present disclosure is not limited to this. In the first modification, the indication image has a cross shape. FIG. 5 is a diagram illustrating a display screen W₂ displayed by the display 5 of the endoscope apparatus 1 according to the first modification of the embodiment. An indication image I₂ illustrated in FIG. 5 has a cross shape in an inverted color (complementary color) of the color of the background image I_{b}. The indication image I₂ is arranged such that, for example, a cross-shaped intersection corresponds to the position of the center of gravity of the region of interest C. In also the first modification, it is possible to obtain the same effect as that described in the above embodiment.

### Second Modification of Embodiment

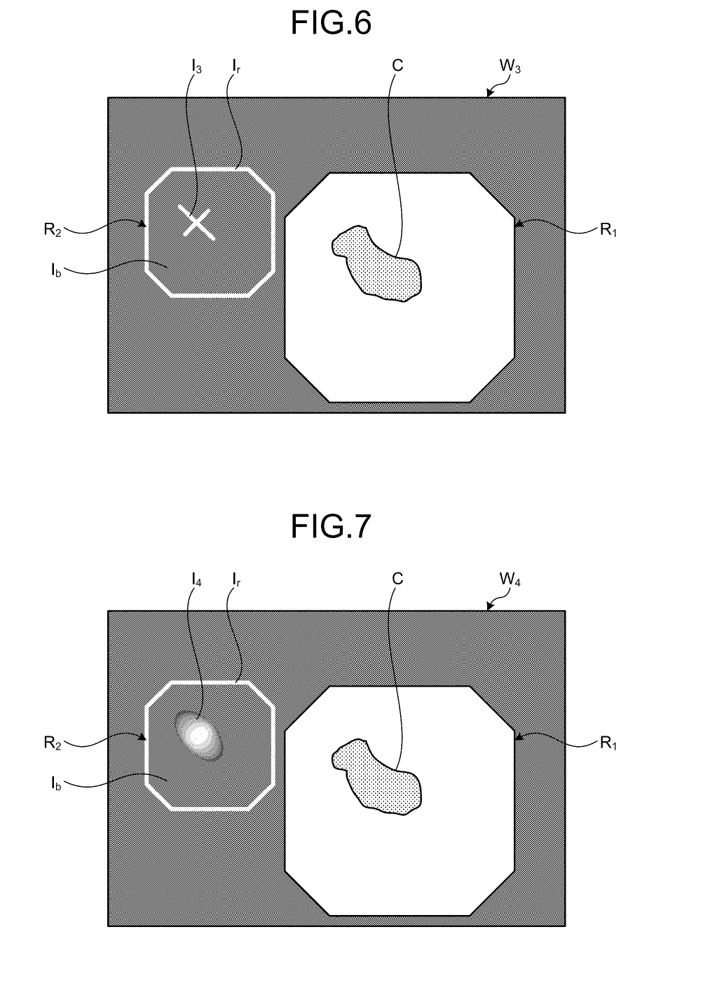

In the first modification described above, a description has been given of a case in which the indication image I₂ has a cross shape parallel to the vertical and horizontal directions of the display screen W₂ regardless of the shape of the region of interest C; however, the present disclosure is not limited to this. In the second modification, the indication image has a cross shape that extends in the longitudinal direction of the region of interest C and in the direction orthogonal to the subject longitudinal direction and that has the length corresponding to each of the directions. FIG. 6 is a diagram illustrating a display screen W₃ displayed by the display 5 of the endoscope apparatus 1 according to a second modification of the embodiment. An indication image I₃ illustrated in FIG. 6 is generated by using the inverted color (complementary color) of the color of the background image I_{b}, has a cross shape that extends in the longitudinal direction of the region of interest C and that extends in the direction orthogonal to the longitudinal direction, and that has the length corresponding to the length in each of the directions. It is preferable that, in the indication image I₃, for example, the cross-shaped intersection correspond to the position of the center of gravity of the region of interest C. In also the second modification, it is possible to obtain the same effect as that described in the above embodiment and grasp the same size of the region of interest C.

### Third Modification of Embodiment

In the embodiment described above, a description has been given of a case in which the indication image I₁ has a rectangular ring shape; however, the present disclosure is not limited to this. In the third modification, the indication image has an oval shape inside of which coloration is performed. FIG. 7 is a diagram illustrating a display screen W₄ displayed by the display 5 of the endoscope apparatus 1 according to a third modification of the embodiment. An indication image I₄ illustrated in FIG. 7 has an elliptical shape inside of which coloration is performed in the inverted color (complementary color) of the color of the background image I_{b}. The indication image I₄ is arranged such that, for example, the center of gravity (the point of intersection of the major axis and the minor axis) of the ellipse corresponds to the position of the center of gravity of the region of interest C and the background transmittance is smaller as the position is closer to the center of gravity. Furthermore, the indication image I₄ is arranged such that the direction of the major axis of the ellipse is parallel to the longitudinal direction of the region of interest C. It is preferable that, in the indication image I₄, the length of the major axis of the ellipse correspond to the length of the region of interest C in the longitudinal direction and the length of the minor axis correspond to the length in the direction orthogonal to the longitudinal direction of the region of interest C. In also the third modification, it is possible to obtain the same effect as that described in the above embodiment. Furthermore, in the indication image I₄, by making the background transmittance smaller as the position is closer to the center of gravity, it is possible to improve the visibility of the position of the center of gravity.

Furthermore, in the second and the third modifications described above, a description has been given of a case in which the indication image has a shape that extends in the longitudinal direction of the region of interest C and in the direction orthogonal to the longitudinal direction and that has the length corresponds to each of the directions; however, the modifications are not limited to this. It may also possible to use at least one of the aspect ratio and the inclination of the region of interest or it may also possible to set the color of the indication image to the inverted color of the object image.

### Fourth Modification of Embodiment

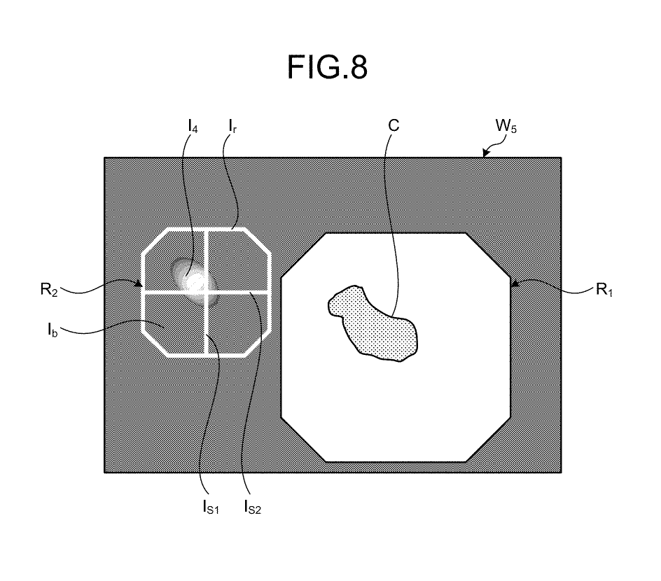

In the embodiment and the first to the third modifications described above, a description has been given of a case in which only the contour image Iᵣ that forms the contour of the second display region R₂ is displayed as the guide line; however, the present disclosure is not limited to this and a guide line that divides the internal space formed by the contour may also further be included. FIG. 8 is a diagram illustrating a display screen W₅ displayed by the display 5 of the endoscope apparatus 1 according to a fourth modification of the embodiment. As illustrated in FIG. 8, the display screen W₅ includes, in addition to the contour image Iᵣ, cross shaped guide lines formed of two linear images (linear image I_{S1} and I_{S2}) that are orthogonal with each other. The linear image I_{S1} extends in the vertical direction from the center of the lateral direction (lateral direction of the rectangular display screen W₅) of the second display region R₂. The linear image I_{S2} extends in the lateral direction from the center of the vertical direction (vertical direction of the rectangular display screen W₅) of the second display region R₂. Consequently, it is possible to obtain the same effect as that described in the above embodiment and more easily grasp the relative position of the indication image I₄ with respect to the second display region R₂. Furthermore, in terms of improving the visibility of the guide lines, it is preferable that the linear images I_{S1} and I_{S2} be arranged so as to be superimposed on the indication image I₄, i.e., such that the guide lines be not hidden by the indication image I₄.

Furthermore, in the fourth modification described above, a description has been given of a case in which the cross shaped guide lines formed by the two straight lines (linear images I_{S1} and I_{S2}) are used; however, the present disclosure is not limited to this. The guide lines may also be formed by using at least one of the lines from among one or a plurality of straight lines and one or a plurality of curved lines, such as the shape of X letter, a grid shape, a star (*) shape, and a radial shape including concentric circles and concentric polygons. Furthermore, the color of the indication image and the color of the guide lines may also be the same or may also be different.

In the embodiment and the first to the fourth modifications described above, a description has been given of a case in which the second display region R₂ is displayed at the position adjacent to the first display region R₁; however, the display position is not limited to this. For example, on the display screen, the second display region R₂ may also be arranged on the right side of the first display region R₁, arranged in the upper left, the lower left, or the upper right of the first display region R₁, or arranged over or below the first display region R₁ and it is preferable that the second display region R₂ be arranged closer to the center of the display screen in terms of improving the visibility. Furthermore, a description has been given of a case in which the size of the second display region R₂ is smaller than that of the first display region R₁; however, the second display region R₂ may also be greater than the first display region R₁. Furthermore, a description has been given of a case in which the contour (the contour image Iᵣ) of the second display region R₂ forms an octagon that is in accordance with the first display region R₁; however, the shape may also be a rectangle and the shape is not limited thereto.

### Fifth Modification of Embodiment

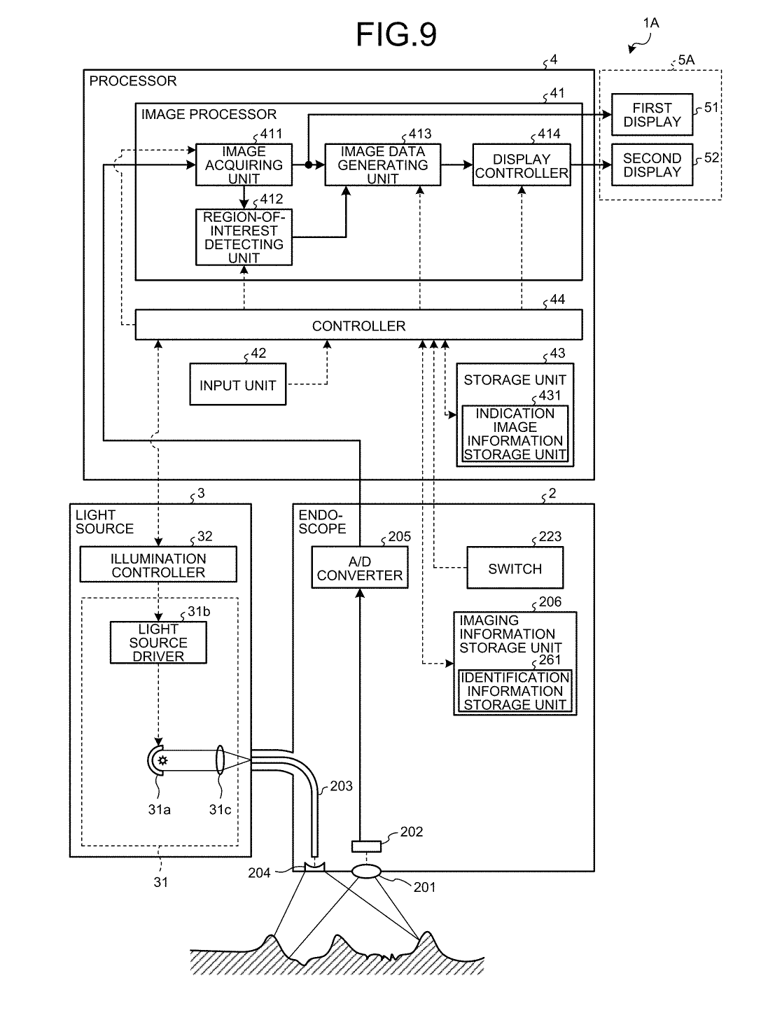

In the embodiment described above, a description has been given of a case in which the image data generating unit 413 generates the first and the second image data and the first image and the second image are displayed on the first display region R₁ and the second display region R₂, respectively, by the display controller 414; however, the present disclosure is not limited to this. In a fifth modification, the first image displayed on the first display region R₁ is input from the image acquiring unit 411. FIG. 9 is a diagram illustrating, in outline, the configuration of an endoscope apparatus according to the fifth modification of the embodiment. An endoscope apparatus 1A according to the fifth modification includes a display 5A, instead of the display 5 in the endoscope apparatus 1 according to the embodiment described above.

The display 5A includes a first display 51 that displays an image on the first display region R₁ and a second display 52 that displays an image on the second display region R₂. The display 5A is formed by using liquid crystals or organic electroluminescence (EL).

In the fifth modification, the image acquiring unit 411 inputs a generated image signal to the first display 51 as the first image data that includes therein the first image and displays the first image on the first display region R₁. In the fifth modification, the image acquiring unit 411 performs image processing for a display as needed. Furthermore, the image data generating unit 413 generates the second image data that includes therein an indication image and inputs the second image data to the display controller 414. The display controller 414 performs control of an input of the second image data generated by the image data generating unit 413 to the second display 52 and a display of the second image onto the second display region R₂.

In this way, in the fifth modification, the first image is displayed on the first display region R₁ without passing through the display controller 414. Furthermore, the second image is input to the second display 52 via the display controller 414 and displayed on the second display region R₂. In also the fifth modification, it is possible to obtain the same effect as that described in the above embodiment. Furthermore, in the fifth modification, the first display region R₁ and the second display region R₂ may also be provided on the display screen of the same monitor or may also be separately provided on two different monitors. Namely, the first display 51 and the second display 52 may also be constituted by the same monitor or constituted by a plurality of different monitors. Furthermore, the first display region R₁ and the second display region R₂ is preferably arranged side by side in terms of ensuring the visibility.

Furthermore, a description has been given of a case in which, in the endoscope apparatus 1 according to the embodiment described above, the A/D converter 205 is provided in the endoscope 2; however, the A/D converter 205 may also be provided in the processor 4. Furthermore, the configuration related to image processing may also be provided in the endoscope 2; a connector that connects the endoscope 2 and the processor 4; the operating unit 22; or the like. Furthermore, a description has been given of a case in which, in the endoscope apparatus 1 described above, the endoscope 2 connected to the processor 4 is identified by using, for example, the identification information stored in the identification information storage unit 261; however, an identification means may also be provided at a connection portion (connector) between the processor 4 and the endoscope 2. For example, the endoscope 2 connected to the processor 4 is identified by providing a pin (identification means) for identification on the endoscope 2 side.

Furthermore, in the embodiment and the first to the fifth modifications described above, a display may also be changed in accordance with the level of skill of a surgeon. In this case, for example, a display mode is set based on information on a surgeon who logs in a device.

Furthermore, in the embodiment and the first to the fifth modifications described above, a description has been given of a case in which a single region of interest has been detected; however, if a plurality of regions of interest is detected in an object image, a plurality of indication images is displayed in accordance with the detected regions of interest. At this time, the indication images according to the embodiment and the first to the fourth modifications described above may also be displayed in combination.

Furthermore, in the embodiment and the first to the fifth modifications described above, a description has been given by using a medical flexible endoscope as an example; however, the endoscope is not limited thereto and a hard endoscope, an industrial endoscope that observes the characteristics of materials, a capsule endoscope, a fiberscope, an endoscope apparatus in which a camera head is connected to an eyepiece portion of an optical endoscope, such as a telescope, may also be used. The image processing apparatus according to the present disclosure may also be used regardless of inside or outside a body and performs a process on a video signal that includes an imaging signal or an image signal generated outside.

According to an aspect of the present disclosure, an advantage is provided in that it is possible to ensure the visibility of an object image and improve the visibility of the information that indicates a region of interest in an object image.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents. The image processing apparatus and the like according to the present disclosure may include a processor and a storage (e.g., a memory). The functions of individual units in the processor may be implemented by respective pieces of hardware or may be implemented by an integrated piece of hardware, for example. The processor may include hardware, and the hardware may include at least one of a circuit for processing digital signals and a circuit for processing analog signals, for example. The processor may include one or a plurality of circuit devices (e.g., an IC) or one or a plurality of circuit elements (e.g., a resistor, a capacitor) on a circuit board, for example. The processor may be a CPU (Central Processing Unit), for example, but this should not be construed in a limiting sense, and various types of processors including a GPU (Graphics Processing Unit) and a DSP (Digital Signal Processor) may be used. The processor may be a hardware circuit with an ASIC. The processor may include an amplification circuit, a filter circuit, or the like for processing analog signals. The memory may be a semiconductor memory such as an SRAM and a DRAM; a register; a magnetic storage device such as a hard disk device; and an optical storage device such as an optical disk device. The memory stores computer-readable instructions, for example. When the instructions are executed by the processor, the functions of each unit of the image processing device and the like are implemented. The instructions may be a set of instructions constituting a program or an instruction for causing an operation on the hardware circuit of the processor.

The units in the image processing apparatus and the like and the display according to the present disclosure may be connected with each other via any types of digital data communication such as a communication network or via communication media. The communication network may include a LAN (Local Area Network), a WAN (Wide Area Network), and computers and networks which form the internet, for example.

What is claimed is:

1. An image processing apparatus comprising a processor comprising hardware,
the processor being configured to:
acquire an object image as first image data;
detect a region of interest that is a target region of interest based on feature data of the object image;
generate second image data that is image data including an indication image indicating information related to the region of interest in the object image and that has an amount of information smaller than an amount of information of the first image data; and
perform control such that a second image corresponding to the second image data is displayed, wherein
a first image corresponding to the first image data is displayed in a first display region, and
the second image corresponding to the second image data is displayed in a second display region.

2. The image processing apparatus according to claim 1, wherein the first image data and the second image data are displayed in the first display region and the second display region, respectively, that are arranged, side by side, on one or a plurality of displays.

3. The image processing apparatus according to claim 1, wherein the processor is configured to generate a background of the second image based on the object image.

4. The image processing apparatus according to claim 1, wherein the second image is an image in which at least one of resolution, saturation, brightness, number of colors, and contrast is reduced compared with the first image.

5. The image processing apparatus according to claim 1, wherein a background of the second image is monochrome.

6. The image processing apparatus according to claim 1, wherein the second image data has a refresh rate lower than that of the first image data.

7. The image processing apparatus according to claim 1, wherein an area of the second display region is equal to or less than an area of the first display region.

8. The image processing apparatus according to claim 1, wherein the indication image has a cross shape.

9. The image processing apparatus according to claim 1, wherein a shape of the indication image corresponds to a shape of the region of interest.

10. The image processing apparatus according to claim 1, wherein the indication image is a diagram having a closed region.

11. The image processing apparatus according to claim 9, wherein the indication image is a diagram inside of which is filled with a solid color.

12. The image processing apparatus according to claim 11, wherein background transmittance of the indication image is smaller as a position is closer to a center of gravity.

13. The image processing apparatus according to claim 1, wherein a display color of the indication image is a complementary color of an average color of the first image.

14. The image processing apparatus according to claim 1, wherein the second image includes a guide line that guides a position of the indication image in the second image.

15. The image processing apparatus according to claim 14, wherein the guide line is formed by using at least one of a contour of the second image, one or a plurality of straight lines, and one or a plurality of curves.

16. The image processing apparatus according to claim 14, wherein the guide line is represented by a complementary color of a background color used on an outer side of the second display region.

17. The image processing apparatus according to claim 14, wherein the guide line is arranged on the indication image.

18. The image processing apparatus according to claim 1, wherein the first display region and the second display region have a similarity relationship.

19. The image processing apparatus according to claim 1, wherein the processor being configured to:
generate the first image data including the object image acquired by the object image acquiring unit, and
perform control such that the first image corresponding to the first image data is displayed in the first display region.

20. An image processing method comprising:
acquiring an object image as first image data;
detecting a region of interest that is a target region of interest based on feature data of the object image;
generating second image data that is image data including an indication image indicating information related to the region of interest in the object image and that has an amount of information smaller than an amount of information of the first image data;
displaying, in a first display region, a first image corresponding to the first image data; and
displaying, in a second display region, a second image corresponding to the second image data.
